(19) United States
(12) Patent Application Publication
(10) Pub. No.: US 2017/0363084 A1
(43) Pub. Date: Dec. 21, 2017

(54) COMPACT, HIGHLY INTEGRATED, OIL LUBRICATED ELECTRIC VACUUM COMPRESSOR

(71) Applicant: WABCO Europe BVBA, Bruxelles (BE)

(72) Inventors: Richard BURN, Huddersfield (GB); Simon WARNER, Pontefract, West Yorkshire (GB)

(21) Appl. No.: 15/541,383

(22) PCT Filed: Feb. 24, 2016
(86) PCT No.: PCT/EP2016/000318

§ 371 Date: Jul. 3, 2017

(30) Foreign Application Priority Data
Apr. 7, 2015 (EP) EP15000979.3

(51) Int. Cl. F04C 18/344; F04C 25/02; B60T 13/52; H02K 7/14; H02K 1/27; B60T 17/02; F04C 29/00

(52) U.S. Cl. CPC F04C 18/344; B60T 17/02; F04C 25/02; F04C 29/0085; H02K 7/14; H02K 1/272; B60T 13/52; F04C 2220/10; F04C 2240/20; F04C 2240/40; F04C 2240/50; F04C 2240/60; F04C 2240/30

(57) ABSTRACT

An electrically driven positive displacement compressor includes an electric drive motor configured to drive the compressor, the electric drive motor including a ring shaped electric stator and an electric rotor arranged inside the ring shaped electric stator and defining a cavity within the electric rotor. The compressor also includes a working chamber having an inlet and an outlet, the working chamber being arranged at least partially inside the cavity of the electric rotor. The compressor additionally includes a compressor rotor arranged inside the working chamber and coupled to the electric rotor.

### CROSS REFERENCE TO RELATED APPLICATIONS

This application is a U.S. National Stage Application under 35 U.S.C. §371 of International Application No. PCT/EP2016/000318 filed on Feb. 24, 2016, and claims benefit to European Patent Application No. EP 15000979.3 filed on Apr. 7, 2015. The International Application was published in English on Oct. 13, 2016 as WO 2016/162100 A1 under PCT Article 21(2).

### FIELD

The invention relates to an electrically driven positive displacement compressor, in particular a vacuum pump, and to a vehicle.

### BACKGROUND

Such compressors, in particular vacuum pumps, may be fitted to road vehicles with gasoline or diesel engines, as well as hybrid and electrical motors. Typically, in the past and with combustion engine vehicles still today, vacuum pumps have been driven by a camshaft of the engine. In general, such a vacuum pump for example is disclosed in WO 2007/116216 A1 in the name of the present Applicant. The disclosed vacuum pump comprises a casing defining a working chamber which is provided with an inlet and an outlet and a movable member is provided in the working chamber, which is movable to draw fluid into the chamber through the inlet and out of the chamber through the outlet so as to induce a reduction in pressure at the inlet. The inlet is connectable to a consumer such as a brake booster or the like. The outlet normally is connected to the engine's crank case, in case a combustion engine is used and the compressor is used in the mode of a vacuum pump. In case the device is used in the compressor mode, the outlet, which provides fluid with an increased pressure, may be used for other applications, such as pneumatic engines.

Nowadays, the electrification of road vehicles increases, so that it becomes necessary to drive the vacuum pump by a separate electric drive motor, instead of coupling the vacuum pump directly to the camshaft of the engine.

It is known to mount an electric drive motor with a vacuum pump of the aforementioned known type, for driving the vacuum pump. Typically, the electric drive motor is coupled to the vacuum pump in an axially adjacent manner, such that a drive shaft of the vacuum pump may be coupled directly or indirectly to an output shaft of the electric drive motor.

The drawback of such solutions is that the dimension of a respective vacuum pump in the axial direction is relatively large, which may result in problems when mounting such a device in the engine's area of a road vehicle where the mounting space typically is very limited.

It has been proposed in WO 2012/007125 A2 to integrate a vacuum vane pump with an electric drive motor. The vacuum pump disclosed in WO 2012/007125 A1 comprises a ring shaped electric rotor carrying a plurality of magnets and a plurality of slidable vanes. The electric rotor defines in it's inside, the working chamber of the vacuum pump. The rotor is provided radially inside a ring shaped electric stator. Inside the working chamber, a pump stator in form of a cylindrical shaft is provided. The pump stator axis is offset to the rotor axis of the electric rotor and the slot between the stator and the rotor is used as the working chamber of the vacuum pump. The vanes, which are carried by the electric rotor intersect the working chamber in radial direction for defining working zones and contact the outer surface of the stator for moving fluid from the inlet to the outlet. A biasing member is provided engaging the radially outer tips of the vanes for biasing the vanes with a predetermined force towards the outer surface of the stator so that a contact between the outer surface of the stator and the vanes is ensured. The rotor of the electric motor and the rotor of the vane pump in this case are the same elements. Thus, the inner surface of a rotor defines the outer surface of the working chamber.

Even though, the axial length of the whole device can be reduced with such an arrangement due to the integration of the electric rotor and the rotor of the vane pump, however, such an arrangement can only be used with multiple vanes, which move along the outer surface of the inner pump stator. Furthermore, such an arrangement faces sealing issues, since the ring shaped rotor needs to be sealed against a casing so that vacuum may be induced effectively at the inlet of the vacuum pump.

### SUMMARY

In an embodiment, the present invention provides an electrically driven positive displacement compressor. The compressor includes an electric drive motor configured to drive the compressor, the electric drive motor including a ring shaped electric stator and an electric rotor arranged inside the ring shaped electric stator and defining a cavity within the electric rotor. The compressor also includes a working chamber having an inlet and an outlet, the working chamber being arranged at least partially inside the cavity of the electric rotor. The compressor additionally includes a compressor rotor arranged inside the working chamber and coupled to the electric rotor.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a schematic full sectional view of a compressor according to an embodiment of the present invention;

FIG. 2 shows a detailed full sectional view of a second embodiment of the present invention; and

FIG. 3 illustrates a vacuum brake booster connected to a compressor according to an embodiment of the present invention, which functions as a vacuum pump.

### DETAILED DESCRIPTION

An electrically driven positive displacement compressor, in particular a vacuum pump, is described herein which is improved with respect to sealing and which may be used with a wider variety and/or flexibility in the design of the working chamber, while keeping the axial length of the vacuum pump as small as possible.

An electrically driven positive displacement compressor, in particular a vacuum pump, described herein includes an electric drive motor for driving the compressor, a working chamber having an inlet and an outlet, wherein the electric drive motor comprises a ring shaped electric stator and an electric rotor arranged inside the ring shaped electric stator and defining a cavity within the electric rotor, and wherein the working chamber is arranged at least partially inside the cavity of the electric rotor. According to embodiments of the invention, a compressor rotor can be arranged inside the working chamber and be coupled to the electric rotor.

According to embodiments of the invention, integration of an electric motor and a compressor, in particular a vacuum pump, can be achieved. When an electric rotor is arranged inside a ring shaped electric stator and defines a cavity, it is possible to arrange the working chamber of the compressor inside this cavity for reducing the axial length of the compressor. At the same time, it is beneficial to use a compressor rotor inside the working chamber, which may be coupled with a movable impeller element, for moving the fluid through the working chamber. Due to this arrangement, only the compressor rotor needs to be sealed against the working chamber and there is no need to seal a ring shaped compressor rotor over its entire circumferential length. Furthermore, the working chamber can be designed more freely inside the cavity of the electric rotor in particular, virtually independent of the design of the electric rotor.

Throughout the following description, when reference is made to a vacuum pump, it shall be understood that this also refers to a compressor and vice versa. If only one of the terms is used, this is only due to simplification.

According to an embodiment of the invention, the electric drive motor can be formed as a brushless motor. Due to this embodiment, the maintenance of the compressor is simplified and also the efficiency may be improved. Since brushes are omitted, wear at the brushes is also omitted. Preferably, the brushless electric motor is a DC motor. This is a particular preferred solution, when the compressor is used in a road vehicle and connected to the electrical system of the road vehicle. Vehicle electrical systems typically provide direct current with limited voltage, so that a brushless DC motor is preferred. Brushless DC motors can be made with relatively large diameter and short axial dimensions. This results in a higher torque and lower rotational speed that is well suited to the characteristics of a positive displacement compressor, in particular vacuum pump. By implementing this Brushless DC motor such that the electric rotor is arranged radially inside the stator, there becomes available a space in the center of the electric rotor which is not required magnetically. This space can instead be used to house a compact compressor or vacuum pump mechanism. The resultant solution may use the compressor or vacuum pump rotor to mount the electric rotor, and so typically eliminates at least one bearing and the conventional coupling between motor and compressor. Overall axial length of the device is reduced to an absolute minimum.

Furthermore, the compressor can include a chamber casing, defining in its inside the working chamber, wherein the chamber casing is arranged at least partially inside the ring shaped electric rotor. The chamber casing defines the geometry of the working chamber and has a smaller diameter than the inner diameter of the electric rotor, so that it can fit inside the cavity inside the electric rotor. The chamber casing preferably is static so that the electric rotor rotates around an outside portion of the chamber casing. Preferably, at least one third of an axial length of the chamber casing is arranged inside the cavity of the electric rotor, much more preferred about the half of the axial length, even more preferred the whole axial length of the chamber casing is arranged inside the cavity of the electric rotor. This specific arrangement is also dependent on how the electric motor is designed, in particular dependent on an axial dimension of the electric motor. Due to this arrangement, an axial integration of the compressor is further obtained, resulting in a shorter overall axial length of the compressor.

It is preferred that the chamber casing be formed of a non-ferromagnetic material, in particular aluminium. This is particularly preferred when a brushless DC motor is used. When the chamber casing is formed of a non-ferromagnetic material the influence of the chamber casing on the magnetic field of the electric motor is reduced, resulting in an increased efficiency and a smooth running of the whole compressor. Furthermore, using aluminium, also the weight of the compressor may be reduced. There are also further alternative materials available which can be used, for example other non-ferromagnetic materials such as titanium or also plastic materials are preferred and can be used in a beneficial way, depending on the specific application.

Furthermore, it is preferred that the chamber casing comprises a cover, for closing the working chamber. The cover preferably is releasably fixed to the chamber casing for providing access to the chamber casing when this is necessary. The cover preferably is formed of the same material as the chamber casing. Thus, the cover also is preferably formed of a non-ferromagnetic material, in particular aluminium. In an embodiment, the inlet and the outlet of the compressor are provided in the cover. Alternatively, inlet and outlet are provided in the chamber casing itself. Providing the inlet and the outlet in the cover, may lead to an even more reduced axial length, since the chamber casing can be arranged to a greater extent inside a cavity formed in the electric rotor.

According to a further preferred embodiment, the rotor engages at least one vane inside the working chamber for rotating the at least one vane to draw fluid into the working chamber through the inlet and out of the working chamber through the outlet. Due to this movement, a reduction in pressure at the inlet is induced and/or an increase in the pressure at the outlet is induced. Preferably, two or more vanes, more preferably four or more vanes are provided. Each vane may be movable in a radial direction of a rotor and may be biased by means of a biasing means, for example a spring or the like against the rotor so that each vane intersects the working chamber from the rotor to an inner wall of a casing of the working chamber for defining working zones.

In a particular preferred embodiment the at least one vane is formed as a single mono vane being slidable provided in a slot formed in the compressor rotor. Such a compressor may be referred as a single vane compressor or vacuum pump. The working chamber in such an embodiment may have a substantially cylindrical inner wall and the mono vane has a length which corresponds to a diameter of the working chamber. The compressor rotor has a slot in which the vane is seated, the slot being preferably formed in a radial direction of the compressor rotor. For increasing the efficiency, a lubrication means may be provided at the compressor rotor for lubricating the vane in the slot. Such arrangement is very simple and biasing means for biasing the single vanes can be omitted in this embodiment.

Furthermore, it is preferred that the compressor chamber comprises a central axis and the electric rotor comprises a rotational axis, wherein the central axis of the working chamber is offset to the rotational axis of the electric rotor. The fact that the compressor chamber comprises a central axis does not necessarily imply that it is circular in cross section. Much more also non-circular cross section are preferred, as e.g. e.g. ellipsoid, cardioid or any other epicycloid form. For inducing a vacuum at the inlet and/or inducing increased pressure at the outlet of the working chamber, it is necessary to form increasing or decreasing working zones within the working chamber for compressing or depressing the fluid in such working zones. Due to this asymmetric arrangement, where the central axis of the working chamber is offset to the rotational axis of the electric rotor, the working zones can be formed in an efficient and simple way.

Furthermore, it is preferred that the rotational axis of the compressor rotor is arranged coaxial to a rotational axis of the electric rotor. Since the compressor rotor is coupled to the electric rotor for rotating the compressor rotor, this arrangement provides a simple transmission of the rotational movement of the electric rotor to the compressor rotor. A transmission between the axis is not necessary and the compressor rotor can be arranged coaxially within the electric rotor and thus within the electric motor in total. This makes it also possible to form the compressor rotor out of a ferromagnetic material, such as steel, which may positively influence the magnetic field within the electric motor, increasing the overall efficiency of the compressor or vacuum pump.

According to a further preferred embodiment, the compressor rotor and the electric rotor are fixedly connected to each other. In particular, when the compressor rotor and the electric rotor are arranged coaxially to each other, this embodiment is preferred. In a particular preferred embodiment, the compressor rotor and the electric rotor are fixed together by means of a press fit. A press fit provides reliable mounting of these two parts without the need of additional elements, resulting in reduced manufacturing costs and reduced maintenance. Alternatively, the compressor rotor and the electric rotor may be formed as a one-piece.

In a further preferred embodiment, the electric rotor is substantially in the form of a cup having a radial ring shaped wall and a bottom wall extending radially there from towards the rotational axis for engaging the compressor rotor. Both, the radial ring shaped side wall and the bottom wall may or may not be solid. For example, the radial side wall may be formed of a solid material and having a substantially hollow cylindrical form, and the bottom wall may be formed as radially extending arms connecting the side wall with the compressor rotor. Preferably, the electric rotor is formed as a one-piece, for example as a deep-drawn part. The bottom wall acts as a connecting mechanism between the compressor rotor and the radial shaped side wall, which preferably carries a plurality of permanent magnets for the electric motor. Due to the cup shaped form, the radial ring shaped side wall of the electric rotor can extend in an axial direction over the working chamber and thus over the chamber casing, so that the axial length of the compressor can be reduced.

Furthermore, it is preferred that the compressor rotor comprises a shaft, the shaft being received in at least one bearing formed in the chamber casing and extending therethrough for engaging the electric rotor. By means of such a shaft, the rotor can easily be connected to the electric rotor and furthermore, the compressor rotor can easily be supported on the chamber casing by means of the shaft. Preferably, the shaft also is received in a bearing formed in the cover. Thus, the compressor rotor is supported in two opposite bearings, leading to a great stability when in operation. When the shaft of the compressor rotor extents to the chamber casing for engaging the electric rotor, it is preferred that suitable sealing means are provided between the chamber casing and the shaft. For example, an 0-ring or a radial shaft seal can be provided. When the shaft is additionally received in a bearing formed in the cover, there is no need that the shaft also intersects the cover. Much more an axial front side end of the shaft may also be received in the cover, so that additional sealing is not required.

It is preferred that the bearing is formed as a sleeve bearing. A sleeve bearing provides beside the bearing effect also to some extent a sealing effect, so that such a bearing is preferred. Furthermore, a sleeve bearing is simple to manufacture. Preferably, an adequate oil lubrication system is provided in the chamber casing for feeding the sleeve bearing with oil. An oil gallery may be provided surrounding the shaft in the area of the sleeve bearing so that sufficient lubrication of the sleeve bearing is ensured. Alternatively, also roller bearings may be used, which however are more difficult to seal against gas passing therethrough.

According to a further preferred embodiment, the compressor includes a housing for housing the drive motor and the chamber casing, wherein the chamber casing is mounted to the housing. The housing in particular receives the stator of the electric motor and supports the stator. The chamber casing is fixed to the housing by means of adequate mounting means, for example of the screw and screw threaded bore type. Therefore, the chamber casing and the stator are in a defined relationship to each other. Since the compressor rotor is in a defined relation to the chamber casing and the electric rotor is engaged to the compressor rotor, also the electric rotor is in a defined relationship to the electric stator, so that a smooth operation and efficient operation of the compressor or vacuum pump is possible.

Furthermore, it is preferred that the electric stator includes a stator winding and the electric rotor comprises a plurality of permanent magnets. The permanent magnets are preferably arranged in a ring shape around the rotor and fixedly connected to the rotor. The permanent magnets are preferably alternatingly poled for forming the electric rotor of the electric motor. Such a design is a simple way of providing a brushless DC motor.

According to a particularly preferred embodiment of the invention, the compressor is executed as a vacuum pump to generate a vacuum pressure for a braking system of a vehicle. Using the compressor as a vacuum pump for generating or inducing a vacuum pressure at the inlet of the compressor is preferred since the above described benefits of the compressor become notably apparent. The braking system is preferably connected with the inlet of the compressor, which in this embodiment is used as a vacuum pump, for providing the braking system with a vacuum source.

In a second aspect of the invention, the problem stated in the introductory portion is solved with a vehicle comprising a compressor according to at least one of the aforementioned preferred embodiments of a compressor according to the first aspect of the invention. It shall be understood that the compressor of the first aspect of the invention and the vehicle of the second aspect of the invention share a plurality of preferred embodiments. Insofar regarding the preferred embodiments and the advantages reference is made to the above discussion of the preferred embodiments and advantages of the first aspect of the invention. Preferably the vehicle is a road vehicle in particular a passenger car or a truck.

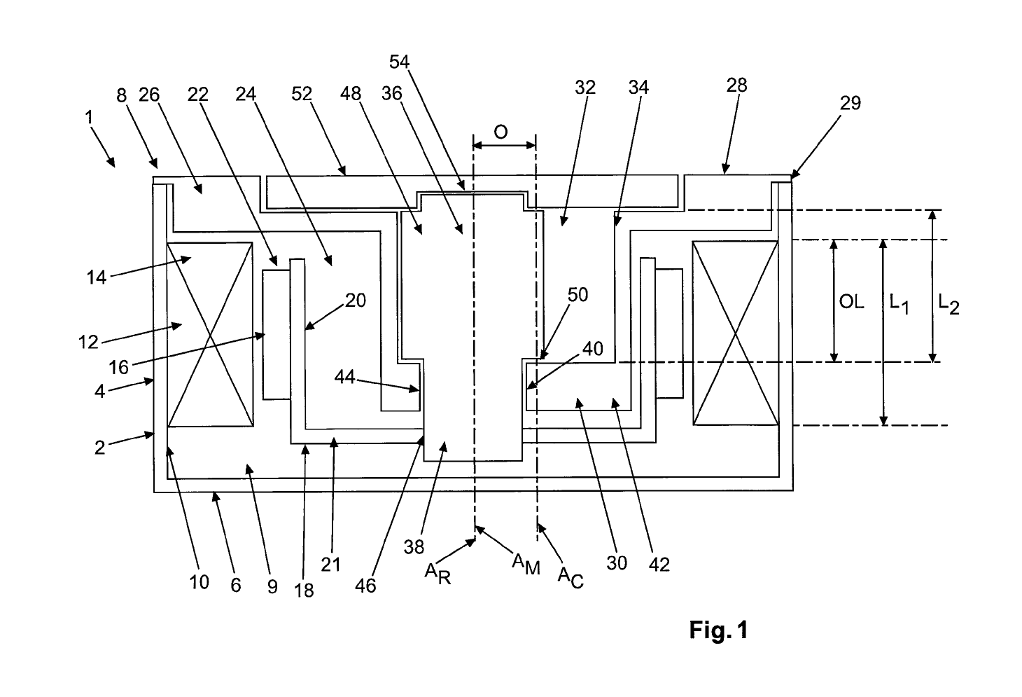

In FIG. 1, a compressor in the form of a vacuum pump 1 is shown. The vacuum pump 1 comprises a housing 2, which substantially encloses the vacuum pump 1 and by means of which the vacuum pump 1 may be mounted at a desired place, for example in the region of an engine of a road vehicle. The housing 2 comprises a substantially ring shaped side wall 4 having a back wall 6 and a front opening 8. An electric drive motor 9 is provided within the housing 2. At a radially inner portion 10 of the ring shaped side wall 4 of the housing 2, an electric stator 12 belonging to the electric drive motor 9 is mounted. The electric stator 12 comprises a stator winding 14 which, in this case, is only shown schematically. The stator 12 is generally in a ring shaped form and extends over an axial length L₁ of a rotational axis A_{M} of the electric drive motor 9. The electric drive motor 9 further comprises an electric rotor 16, which is rotatable about the axis A_{M} and arranged radially inside the electric stator 12. The electric rotor 16 comprises a substantially cup shaped body 18, the body 18 having a substantially ring shaped side wall 20 and a substantially flat bottom wall 21, wherein on the sidewall 20 a plurality of permanent magnets 22 is provided. When the stator winding 14 of the electric stator is provided with a stator current, a magnetic field is induced inside the stator 12 and the electric rotor 16 is forced into rotation about axis A_{M}.

Since the electric rotor 16 is a substantially cup shaped form, and having the substantially ring shaped wall 20, a cavity 24 is provided radially inside the electric rotor 16. Therefore, one can call the electric motor 9 a hollow motor, or an inside-out outrunner electric motor.

The vacuum pump 1 furthermore comprises a chamber casing 26 which is fixed via a mounting portion 28 against a corresponding mounting portion 29 of the housing 2. The casing 26 may be fixed to the housing 2 by known fixing means, such as screw and screw threaded bores, clamping or clipping means or the like. The casing 26 comprises a cup shaped portion 30 extending from the opening 8 of the housing 2 in an axial direction along axis A_{M} into the electric motor 9 and intersects the rotor 16 substantially. Radially inside of the cup shaped portion 30 of the casing 26 a working chamber 32 of the vacuum pump 1 is defined. Therefore, the working chamber 32 is substantially arranged radially inside the electric motor 9, in particular inside the electric rotor 16. The working chamber 32 comprises a radial side wall 34, which is substantially cylindrical shaped, even though this is not mandatory. It should be understood that the working chamber may have a cross section which is not circular, but e.g. formed according to an ellipsoid, a cardioid or any other epicycloid form. The working chamber 32 comprises a central axis A_{C}, which is parallel to the rotational axis A_{M} of the electric motor 9, however offset to this axis A_{M} by an offset O. The working chamber 32 extends over an axial length L₂ of the axis A_{C} and A_{M}, respectively. As can be seen in FIG. 1, the axial length L₁ of the electric motor 9 and the axial length L₂ of the working chamber 32 are nearly congruent to each other, beside a small offset, caused by mechanical constrains of vacuum pump 1. Due to this arrangement, the overall axial length is reduced at least by the amount of overlap O_{L} of the electric motor 9 and the working chamber 32 in the axial direction. Therefore, the axial dimensions of the vacuum pump 1 according to this embodiment are substantially reduced when compared to known vacuum pumps, in which usually the electric drive motor is arranged axially adjacent to the working chamber.

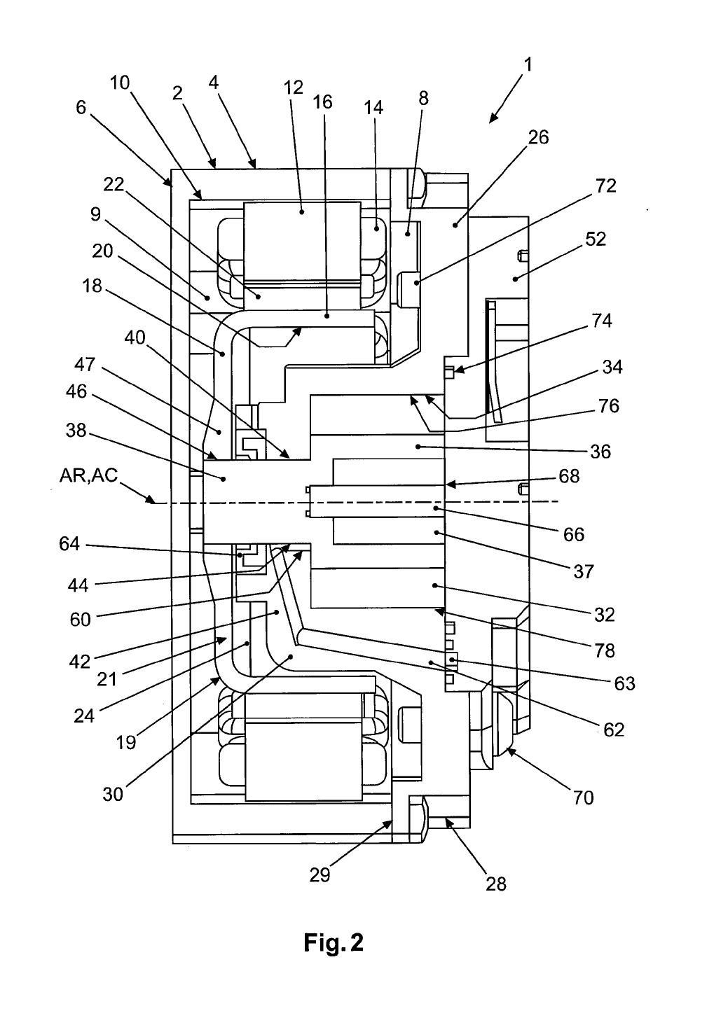

Furthermore, a compressor rotor 36 is provided in the working chamber 32. The compressor rotor 36 comprises a rotational axis A_{R} which is identical to the rotation axis A_{M} of the electric motor 9. The compressor rotor 36 comprises a shaft 38 extending through an opening 40 in a bottom portion 42 of the cup shaped portion 30 of the casing 26. In the area of the opening 40 a bearing 44 is provided in the form of a sleeve bearing (see also FIG. 2). At an outside portion of the cup shaped portion 30 the shaft 38 engages an engagement portion 46. According to the embodiment shown in FIG. 1, the engagement portion 46 is formed by an opening in a bottom wall 21 of the cup shaped rotor body 18. The bottom wall 21 according to this embodiment connects the ring shaped side wall portion 20 of the electric rotor 16 with the engagement portion 46 for engaging the electric rotor 16 to the compressor rotor 36. According to this embodiment, the side wall 20 and the bottom wall 21 are formed as a one-piece by means of a deep-drawing process. However, in alternative embodiments, the side wall 20 and the bottom wall 21 are separate pieces, mounted together. The bottom wall 21 may be for example formed as a strut or struts connecting the ring shaped portion 20 of the rotor body 18 to the compressor rotor 36. By means of the engagement portion 46, according to this embodiment, the electric rotor 16 is mounted to the shaft 38 by means of a press fit.

As can be seen in FIG. 1, the engagement point between the bottom wall 21 and the shaft 38 is substantially arranged adjacent to the electric motor 9 in an axial direction, thus, not inside the electric motor 9. However, the ring shaped side wall 20 is supported by the bottom wall 21 so that it extends into the electric motor 9 for holding the magnets 22 in place. Thus, the electric rotor 16 extends over the working chamber 32 and thus over the casing 26, defining in it's inside the working chamber 32. Since the casing 26, in particular the cup shaped portion 30 of the casing 26 is not arranged symmetrically inside the electric motor 9, but offsets by the offset O, it is preferred that the casing 26 is formed out of a non-ferromagnetic material, such as aluminum. According to this embodiment, the casing 26 is formed out of aluminium. The sleeve bearing 44 preferably is formed also out of a non-ferromagnetic material, for example copper or brass. The rotor 16 and also the housing 2 may be formed out of a ferromagnetic material, such as steel. Also the compressor rotor 36 may be formed out of steel, since it is engaged to the electric rotor 18, rotating at the same rotational speed and also is being arranged in a rotational symmetrical way inside the electric motor 9.

The compressor rotor 36 moreover comprises a portion 48 with an enlarged diameter forming an abutment 50 at the transition portion to the shaft 38, for abutting at an inside portion of the bottom wall 42 of the cup shaped portion 30. Due to this arrangement, a beneficial sealing of the compressor rotor 36 is provided. The shaft 38 and the enlarged diameter portion 48 can be formed as a one-piece so that the compressor rotor 36 is formed as a one-piece in whole. The enlarged diameter portion 48 carries a movable impeller member, such as a vane (see also FIG. 2) for rotation inside the working chamber 32.

The working chamber 32 is closed by means of a cover 52, mounted against the casing 26. The cover 52 is formed as a substantially flat plate, and may be mounted against the casing 26 by means of screws and corresponding screw threaded bores in the casing 26. Alternatives for mounting the cover 52 to the casing 26 are known. The cover 52 according to this embodiment comprises a recess 54 receiving a portion of the shaft 38, which extends from the enlarged diameter portion 48 of the compressor rotor 36, opposite the bearing 44. In the recess 54 an additional sleeve bearing is provided, so that the compressor rotor 36 is received in two opposite arranged bearings. The cover 52 is preferably formed out of the same material as the casing 26, in this case aluminium.

Now, turning to FIG. 2, a more detailed embodiment of a vacuum pump 1 according to the invention is shown. The vacuum pump 1 according to FIG. 2 has substantially the same design as the vacuum pump 1 according to FIG. 1, and similar and identical parts are shown with the same reference signs as used above. Insofar, reference is also made to the above description with respect to FIG. 1 and in the following the focus of the description will be on the differences between FIG. 1 and FIG. 2.

According to FIG. 2, the vacuum pump 1 again comprises a housing 2 having a radial side wall 4 and a back wall 6. Inside the housing 2 an electric motor 9 is provided in the form of a brushless DC motor, having a stator 12 comprising a stator winding 14 and a rotor 16 carrying on its body 18 permanent magnets 22. The rotor 16 is arranged radially inside the electric stator 12 and defines a cavity 24 radially inside the electric rotor 16. The electric rotor 16 is again substantially cup shaped having a bottom wall 21 and a substantially ring shaped side wall 20. According to this embodiment (FIG. 2), the rotor 16 is solid and the rotor body 18 having the ring shaped side wall 20 and the bottom wall 21 is formed as one-piece by means of a deep-drawing. Therefore, the side wall 20 and the bottom wall 21 are connected to each other by a curved portion 19, providing a smooth transition between the radial extending bottom wall 21 and the circumferentially arranged side wall 20. At the engagement portion 46 of the electric rotor 16 and the shaft 38 of the compressor rotor 36, the bottom wall 18 comprises a portion 47 with enlarged wall thickness, for providing a solid press fit between the electric rotor 16 and the compressor rotor 36.

In accordance with the first embodiment (FIG. 1) also vacuum pump 1 of the second embodiment 2 comprises a casing 26 having a cup shaped portion 30 and defining a working chamber 32, which is substantially arranged inside the cavity 24. The bottom wall 42 of the cup shaped portion 30 according to this embodiment again comprises an opening 40 providing a sleeve bearing 44 for the shaft 38. The sleeve bearing 44 according to this embodiment comprises an oil gallery 60, connected with an oil supply conduit 62, which is formed in the casing 26 and connected to a source of oil 63. By means of this conduit 62, the oil gallery 60 is provided with constant flow of oil, which also may flow to a certain extent into the working chamber 32 for lubricating the compressor rotor 36 and in particular a moving member, which rotates inside the working chamber 32. At a distal portion of the opening 40, with respect to the working chamber 32, a sealing element 64 is provided around the shaft 38 for sealing the sleeve bearing 44 and the working chamber 32 against the environment, in particular against the electric motor 9 so that no oil flows from the sleeve bearing 44 into the electric motor 9.

The movable member in this embodiment is formed as a mono-vane 66. The mono-vane 66 is provided in a slot 68 formed in the rotor 36, which in this embodiment is formed as a hollow rotor defining an inner cavity 37. The vane 66 can move relative to the rotor 36 in a radial direction of the rotor 36, thus, longitudinal in the vane direction 66. The vane 66 is in contact always with two opposing points of the inner wall 34 of the working chamber 32. Oil, which flows from the sleeve bearing 44 into the working chamber 32 also serves for sealing the vane 66 against the wall 34 and providing a smooth operation of the vacuum pump 1.

The cover 52 is also in this embodiment formed out of aluminium, as well as the casing 26. The cover 52 is mounted against the casing 26 by means of screws 70, 72, from which only two can be seen in FIG. 2. The cover 52 comprises a ring shaped recess 74, which runs around the working chamber 32. The recess 74 can receive a sealing element, such as an O-ring or the like, so that the cover 52 can seal against the casing 26 in a fluid-tight manner.

As can be seen in FIG. 2, the inlet 78 of the working chamber 32 is provided proximal to the cover 52, but actually outside the electric motor 9. The corresponding outlet 76 is provided in opposite side of the inlet 78, also proximal to the cover 52.

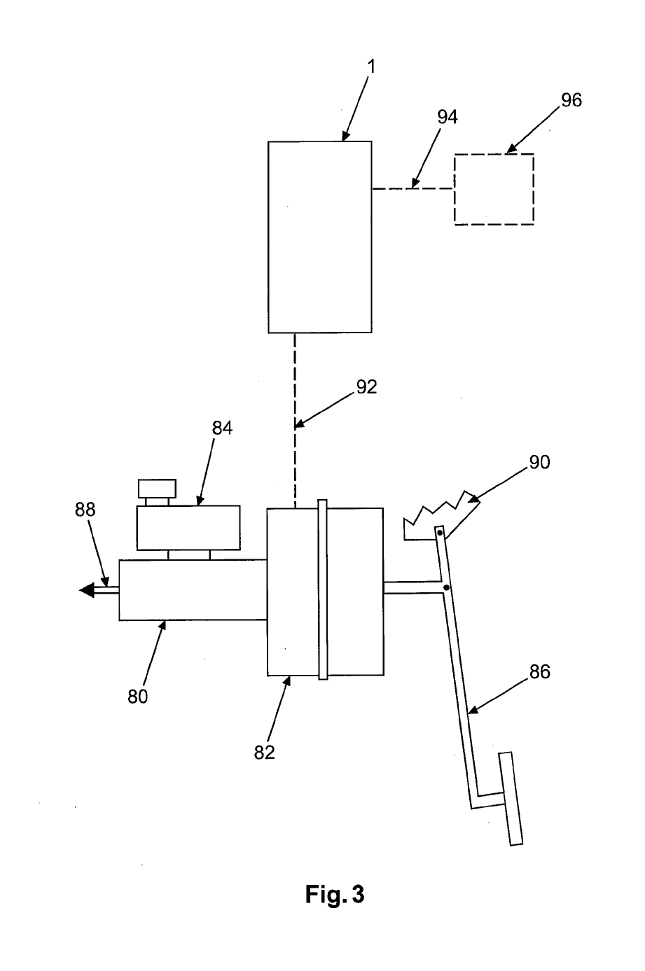

FIG. 3 illustrates schematically a typical installation of the invention with respect to a vehicle hydraulic brake circuit, including the usual brake master cylinder 80, vacuum booster 82, fluid reservoir 84 and a brake pedal 86. The hydraulic output of the master cylinder 80 is represented by the arrow 88 and the vehicle structure is schematically shown with reference sign 90.

The compressor 1 formed as a vacuum pump is connected to the vacuum chamber of the booster 82 via a vacuum duct 92. The vacuum pump 1 therefore provides a vacuum via the vacuum duct 92 to the vacuum chamber of the booster, when required. The compressor 1 is furthermore connected via a signal line 94 to the electrical system 96 of the vehicle (the electrical systems only show by means of a dashed square in FIG. 3). Via the signal line 94 the compressor receives electrical energy and also signals, so that the compressor 1 may only be switched on, when required. This helps to save energy or fuel and reduces unnecessary running time of the compressor 1.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1 vacuum pump

2 housing

4 side wall

6 back wall

8 front opening

9 electric drive motor

10 inner portion

12 electric stator

14 stator winding

16 electric rotor

18 cup shaped body of rotor

19 curved portion

20 ring shaped side wall

21 bottom wall

22 permanent magnets

24 cavity

26 chamber casing

28 mounting portion

29 mounting portion

30 cup shaped portion

32 working chamber

34 radial side wall

36 compressor rotor

38 shaft

40 opening

44 sleeve bearing

46 engagement portion of compressor rotor

48 enlarged diameter portion of compressor rotor

50 abutment of compressor rotor

52 cover

54 recess in cover

60 oil gallery

62 oil supply conduit

63 source of oil

64 sealing element

66 vane

68 slot

70 screws

72 screws

74 recess

76 outlet

78 inlet

80 brake master cylinder

82 vacuum booster

84 fluid reservoir

86 brake pedal

88 hydraulic output of the master cylinder

90 vehicle structure

92 vacuum duct

94 signal line

96 electrical system

A_{M} rotational axis motor

A_{C} central axis

A_{R} rotational axis rotor

O offset

O_{L} overlap

L₁ axial length

L₂ axial length

1. An electrically driven positive displacement compressor, comprising:
an electric drive motor configured to drive the compressor, the electric drive motor comprising:
a ring shaped electric stator, and
an electric rotor arranged inside the ring shaped electric stator and defining a cavity within the electric rotor;
working chamber having an inlet and an outlet, the working chamber being arranged at least partially inside the cavity of the electric rotor; and
a compressor rotor arranged inside the working chamber and coupled to the electric rotor.

2. The compressor according to claim 1, wherein the electric drive motor is a brushless motor.

3. The compressor according to claim 1, further comprising a chamber casing defining in its inside the working chamber, wherein the chamber casing is arranged at least partially inside the ring shaped electric rotor.

4. The compressor according to claim 3, wherein the chamber casing is formed out of a non-ferromagnetic material.

5. The compressor according to claim 1, wherein the compressor rotor engages at least one vane inside the working chamber and is configured to rotate the at least one vane to draw fluid into the working chamber through the inlet and to expel fluid out of the working chamber through the outlet.

6. The compressor according to claim 5, wherein the vane is formed as a single mono vane slidably disposed in a slot formed in the compressor rotor.

7. The compressor according to claim 1, wherein the working chamber comprises a central axis and the electric rotor comprises a rotational axis, and wherein the central axis of the working chamber is offset relative to the rotational axis of the electric rotor.

8. The compressor according to claim 1, wherein a rotational axis of the compressor rotor is arranged coaxial to a rotational axis of the electric rotor.

9. The compressor according to claim 1, wherein the compressor rotor and the electric rotor are fixedly connected to each other.

10. The compressor according to claim 1, wherein the electric rotor is in the form of a cup having a radial ring shaped side wall and a bottom wall extending radially from the side wall towards the rotational axis for engaging the compressor rotor.

11. The compressor according to claim 3, wherein the compressor rotor comprises a shaft, the shaft being received in at least one bearing formed in the chamber casing and extending there through for engaging the electric rotor.

12. The compressor according to claim 3, further comprising a housing for housing the drive motor and the chamber casing, wherein the chamber casing is mounted to the housing.

13. The compressor according to claim 1, wherein the electric stator comprises a stator winding and the electric rotor comprises a plurality of permanent magnets.

14. The compressor according to claim 1, wherein the compressor is employed as a vacuum pump configured to generate a vacuum pressure for a braking system of a vehicle.

15. A vehicle comprising a compressor according to claim 1.
